(19) United States
(12) Patent Application Publication
(10) Pub. No.: US 2015/0350928 A1
(43) Pub. Date: Dec. 3, 2015

(54) METHOD FOR INTERFERENCE CANCELLATION WITH LOW-POWER SUBFRAMES IN HETEROGENEOUS NETWORKS

(71) Applicants: Lili ZHANG, Beijing (CN); Haiming WANG, Beijing (CN); Tero Heikki Matti HENTTONEN, Espoo (FI)

(72) Inventors: Lili ZHANG, Beijing (CN); Haiming WANG, Beijing (CN); Tero Heikki Matti HENTTONEN, Espoo (FI)

(21) Appl. No.: 14/759,552

(22) PCT Filed: Jan. 9, 2013
(86) PCT No.: PCT/CN2013/070273

§ 371 Date: Jul. 7, 2015

(51) Int. Cl. H04W 24/02; H04W 52/24; H04W 36/00; H04W 52/40

(52) U.S. Cl. CPC H04W 24/02; H04W 52/40; H04W 52/244; H04W 36/0083; H04W 88/08

(57) ABSTRACT

Embodiments include methods for providing information enabling a communication device operating in a hetnet comprised of an aggressor cell and one or more overlaid victim cells utilizing a common frequency spectrum, to at least partially cancel an interfering signal transmitted from the aggressor cell in order to more accurately measure one or more signals transmitted from a victim cell. Embodiments include methods for configuring the aggressor cell with information related to overlaid victim cells in the aggressor's coverage area, and methods for configuring a victim cell with information related to the aggressor's interference within the victim's extended coverage area. Embodiments also include methods for receiving measurements of a signal transmitted from a victim cell, and methods for making such measurements on the victim's signal utilizing the aggressor cell interference information. Embodiments include network equipment or apparatus, user equipment or apparatus, and computer-readable media embodying one or more of these methods.

### TECHNICAL FIELD

The disclosure herein relates to the field of wireless or cellular communications, and more particularly to methods, devices, network equipment, and user equipment used to measure various characteristics of signals transmitted from victim cells in a heterogeneous network (hetnet) in the presence of interfering signals transmitted by aggressor cells.

### BACKGROUND

The Third Generation Partnership Project (3GPP) unites six telecommunications standards bodies, known as “Organizational Partners,” and provides their members with a stable environment to produce the highly successful Reports and Specifications that define 3GPP technologies. These technologies are constantly evolving through what have become known as “generations” of commercial cellular/mobile systems. 3GPP also uses a system of parallel “releases” to provide developers with a stable platform for implementation and to allow for the addition of new features required by the market. Each release includes specific functionality and features that are specified in detail by the version of the 3GPP standards associated with that release.

Universal Mobile Telecommunication System (UMTS) is an umbrella term for the third generation (3G) radio technologies developed within 3GPP and initially standardized in Release 4 and Release 99, which preceded Release 4. UMTS includes specifications for both the UMTS Terrestrial Radio Access Network (UTRAN) as well as the Core Network. UTRAN includes the original Wideband CDMA (W-CDMA) radio access technology that uses paired or unpaired 5-MHz channels, initially within frequency bands near 2 GHz but subsequently expanded into other licensed frequency bands. The UTRAN generally includes node-Bs (NBs) and radio network controllers (RNCs). Similarly, GSM/EDGE is an umbrella term for the second-generation (2G) radio technologies initially developed within the European Telecommunication Standards Institute (ETSI) but now further developed and maintained by 3GPP. The GSM/EDGE Radio Access Network (GERAN) generally comprises base stations (BTSs) and base station controllers (BSCs).

Long Term Evolution (LTE) is another umbrella term for so-called fourth-generation (4G) radio access technologies developed within 3GPP and initially standardized in Releases 8 and 9, also known as Evolved UTRAN (E-UTRAN). As with UMTS, LTE is targeted at various licensed frequency bands, including the 700-MHz band in the United States. LTE is accompanied by improvements to non-radio aspects commonly referred to as System Architecture Evolution (SAE), which includes Evolved Packet Core (EPC) network. LTE continues to evolve through subsequent releases. One of the features of Release 11 is an enhanced Physical Downlink Control Channel (ePDCCH), which has the goals of increasing capacity and improving spatial reuse of control channel resources, improving inter-cell interference coordination (ICIC), and supporting antenna beamforming and/or transmit diversity for control channel.

Global mobile data traffic has tripled each year since 2008 and it is projected to increase 26-fold between 2010 and 2015. To address this exponential growth in demand, network operators are aggressively overlaying smaller cells (also known as “pico cells”) on top of existing macro cells. Pico cell eNBs (peNBs) are typically deployed by network operators in wireless hotspot areas (e.g., malls) and provide access to all users, albeit with transmit power typically an order of magnitude less than macro cell eNBs (meNBs). The combined macro cell/pico cell topology is known in 3GPP parlance as a heterogeneous network or “hetnet.” Users with poor coverage at the edge of macro cells can be offloaded to an overlaid pico cell, where they will receive a higher quality of service. Because of the relative proximity of users and the reduced transmit power of peNBs, more users can receive a given quality of service within the same area in a hetnet compared to a conventional network consisting only of meNBs. This is commonly known as a “cell-splitting” gain.

### SUMMARY

Embodiments of the present disclosure include methods for providing information that enables a communication device (e.g., a UE), operating in a hetnet comprised of an aggressor cell (e.g., meNB) and one of more overlaid victim cells (e.g., peNBs) utilizing a common frequency spectrum, to at least partially cancel an interfering signal (e.g., cell-specific reference signal or CRS) transmitted from the aggressor cell in order to more accurately measure one or more characteristics (e.g., channel state information (CSI) or radio resource management (RRM) information) of one or more signals transmitted from a victim cell. Embodiments include methods for configuring the aggressor cell with information related to victim cells overlaid in the aggressor cell's coverage area, and methods for configuring a victim cell with information related to interference of the aggressor cell within the particular victim cell's coverage area. Embodiments also include methods for receiving measurements of a signal transmitted from a victim cell, and methods for making such measurements on the victim cell signal utilizing the information related to the interference of the aggressor cell. Other embodiments include network equipment or apparatus (e.g., OA&M server or eNB), user equipment or apparatus (e.g., UEs), and computer-readable media embodying one or more of these methods.

### DESCRIPTION OF THE DRAWINGS

The detailed description will refer to the following drawings, wherein like numerals refer to like elements, and wherein:

FIG. 1 is a high-level block diagram of the architecture of the Long Term Evolution (LTE) Evolved UTRAN (E-UTRAN) and Evolved Packet Core (EPC) network, as standardized by 3GPP;

FIG. 2A is a high-level block diagram of the E-UTRAN architecture in terms of its constituent components, protocols, and interfaces;

FIG. 2B is a block diagram of the protocol layers of the control-plane portion of the radio (Uu) interface between a user equipment (UE) and the E-UTRAN;

FIG. 2C is a block diagram of the LTE radio interface protocol architecture from the perspective of the PHY layer;

FIG. 3 is block diagram of the type-1 LTE radio frame structure used for both full-duplex and half-duplex FDD operation;

FIG. 4A is a block diagram illustrating one manner in which control channel elements (CCEs) and resource element groups (REGs) for a PDCCH can be mapped with a PDSCH into LTE physical resource blocks (PRBs);

FIG. 4B is a block diagram illustrating one manner in which a PDCCH and a PDSCH can be mapped into PRBs along with cell-specific reference signal (CRS) overhead;

FIG. 5A is a block diagram of an exemplary heterogeneous network (hetnet) comprised of a macro cell and a plurality of overlaid pico cells that employ cell range expansion (CRE), according to embodiments of the present disclosure;

FIG. 5B is a diagram showing exemplary downlink subframes transmitted by a macro cell and a pico cell in a hetnet (e.g., FIG. 5A) where the macro cell utilizes almost blank subframes (ABS), according to embodiments of the present disclosure;

FIG. 6 is a diagram showing exemplary downlink subframes transmitted by a macro cell and two pico cells in a hetnet (e.g., FIG. 5A) where the macro cell utilizes low-power almost blank subframes (LP-ABS), according to embodiments of the present disclosure;

FIGS. 7A, 7B, 7C, 7D, and 7E are flowcharts of exemplary methods for wireless communication devices and network equipment, according to various embodiments of the present disclosure;

FIG. 8A is an exemplary table showing assignment of sustainable macro cell interference levels to pico cells within a hetnet, according to embodiments of the present disclosure;

FIG. 8B is a diagram showing an exemplary set of relationships between LP-ABS subframes transmitted by a macro cell in a hetnet and Measurement Subsets for pico cells associated with two different interference levels, according to embodiments of the present disclosure;

FIG. 9 is a block diagram of an exemplary apparatus, such as a wireless communication device or apparatus, according to one or more embodiments of the present disclosure; and

FIG. 10 is a block diagram of an exemplary apparatus, such as network equipment or apparatus, according to one or more embodiments of the present disclosure.

### DETAILED DESCRIPTION

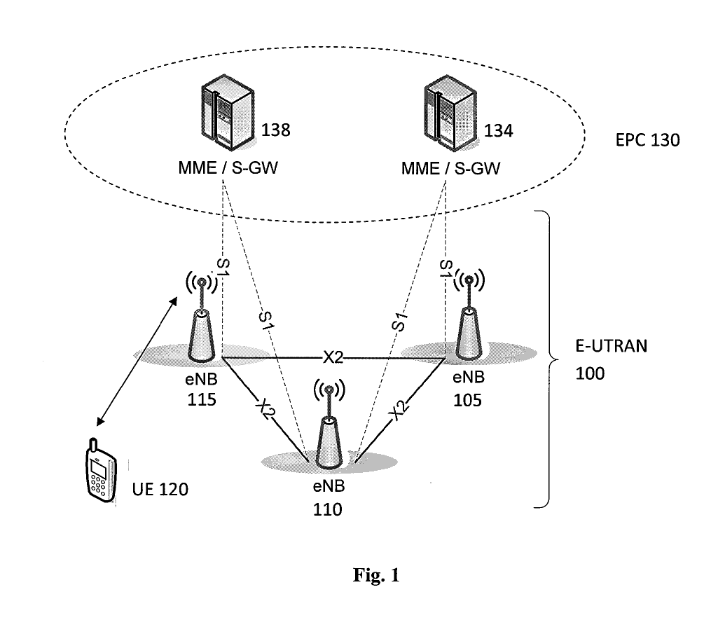

The overall architecture of a network comprising LTE and SAE is shown in FIG. 1. E-UTRAN 100 comprises one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, such as UTRAN, E-UTRAN, and/or GERAN, as the second-generation (“2G”) 3GPP radio access network is commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. The eNBs in the E-UTRAN communicate with each other via the X2 interface, as shown in FIG. 1A. The eNBs also are responsible for the E-UTRAN interface to the EPC, specifically the S1 interface to the Mobility Management Entity (MME) and the Serving Gateway (SGW), shown collectively as MME/S-GWs 134 and 138 in FIG. 1A. Generally, the MME/S-GW handles both the overall control of the UE and data flow between the UE and the rest of the EPC. More specifically, the MME processes the signaling protocols between the UE and the EPC, which are known as the Non Access Stratum (NAS) protocols. The S-GW handles all Internet Protocol (IP) data packets between the UE and the EPC, and serves as the local mobility anchor for the data bearers when the UE moves between eNBs, such as eNBs 105, 110, and 115.

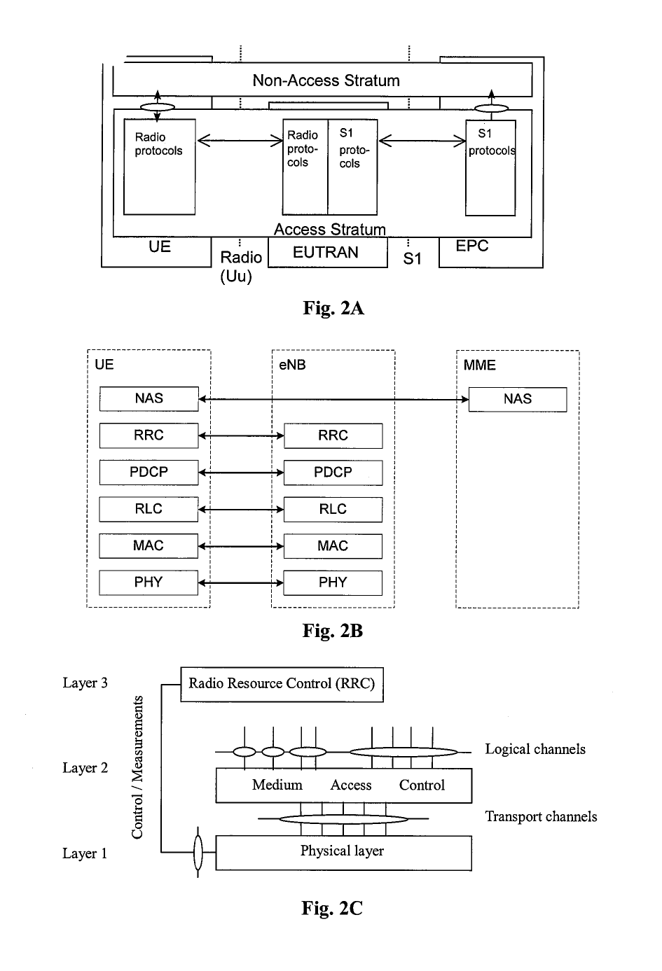

FIG. 2A is a high-level block diagram of LTE architecture in terms of its constituent entities—UE, E-UTRAN, and EPC—and high-level functional division into the Access Stratum (AS) and the Non-Access Stratum (NAS). FIG. 1 also illustrates two particular interface points, namely Uu (UE/E-UTRAN Radio Interface) and S1 (E-UTRAN/EPC interface), each using a specific set of protocols, i.e., Radio Protocols and S1 Protocols. Each of the two protocols can be further segmented into user plane (or “U-plane”) and control plane (or “C-plane”) protocol functionality. On the Uu interface, the U-plane carries user information (e.g., data packets) while the C-plane is carries control information between UE and E-UTRAN.

FIG. 2B is a block diagram of the C-plane protocol stack on the Uu interface comprising Physical (PHY), Medium Access Control (MAC), Radio Link Control (RLC), Packet Data Convergence Protocol (PDCP), and Radio Resource Control (RRC) layers. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PHY, MAC, and RLC layers perform identical functions for both the U-plane and the C-plane. The PDCP layer provides ciphering/deciphering and integrity protection for both U-plane and C-plane, as well as other functions for the U-plane such as header compression.

FIG. 2C is a block diagram of the LTE radio interface protocol architecture from the perspective of the PHY. The interfaces between the various layers are provided by Service Access Points (SAPs), indicated by the ovals in FIG. 2C. The PHY layer interfaces with the MAC and RRC protocol layers described above. The MAC provides different logical channels to the RLC protocol layer (also described above), characterized by the type of information transferred, whereas the PHY provides a transport channel to the MAC, characterized by how the information is transferred over the radio interface. In providing this transport service, the PHY performs various functions including error detection and correction; rate-matching and mapping of the coded transport channel onto physical channels; power weighting, modulation; and demodulation of physical channels; transmit diversity, beamforming multiple input multiple output (MIMO) antenna processing; and providing radio measurements to higher layers, such as RRC. Downlink (i.e., eNB to UE) physical channels provided by the LTE PHY include Physical Downlink Shared Channel (PDSCH), Physical Multicast Channel (PMCH), Physical Downlink Control Channel (PDCCH), Relay Physical Downlink Control Channel (R-PDCCH), Physical Broadcast Channel (PBCH), Physical Control Format Indicator Channel (PCFICH), and Physical Hybrid ARQ Indicator Channel (PHICH).

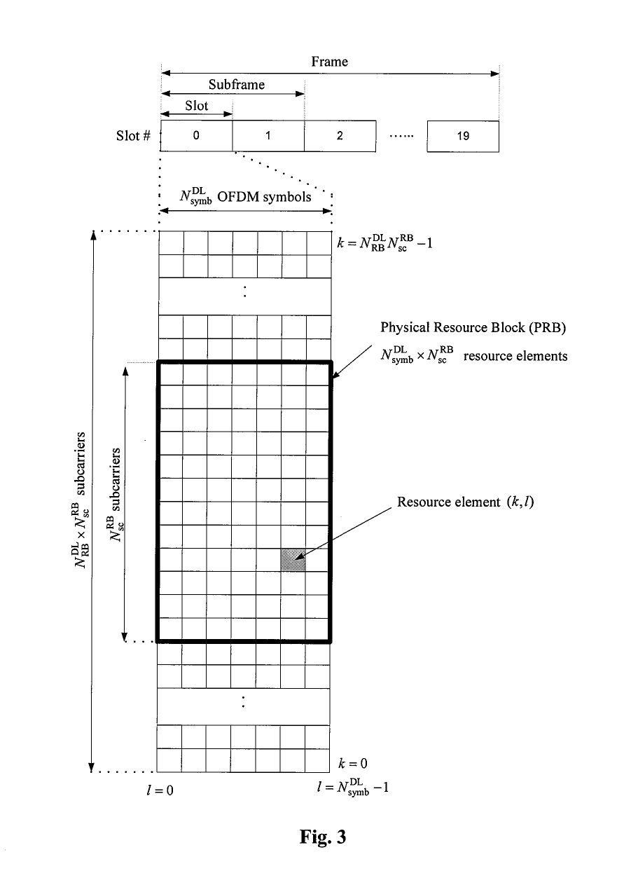

The multiple access scheme for the LTE PHY is based on Orthogonal Frequency Division Multiplexing (OFDM) with a cyclic prefix (CP) in the downlink, and on Single-Carrier Frequency Division Multiple Access (SC-FDMA) with a cyclic prefix in the uplink. To support transmission in paired and unpaired spectrum, the LTE PHY supports both: Frequency Division Duplexing (FDD) (including both full- and half-duplex operation) and Time Division Duplexing (TDD). FIG. 3 shows the radio frame structure (“type 1”) used for both full-duplex and half-duplex FDD operation. The radio frame has a duration of 10 ms and consists of 20 slots, labeled 0 through 19, each with a duration of 0.5 ms. A 1-ms subframe comprises two consecutive slots where subframe i consists of slots 2i and 2i+1. Each slot consists of N^{DL}_{symb} OFDM symbols, each of which is comprised of N_{sc} OFDM subcarriers. The value of N^{DL}_{symb} is typically 7 (with a normal CP) or 6 (with an extended-length CP) for subcarrier bandwidth of 15 kHz. The value of N_{sc} is configurable based upon the available channel bandwidth. Since persons of ordinary skill in the art will be familiar with the principles of OFDM, further details are omitted in this description.

As shown in FIG. 3, the combination of a particular subcarrier in a particular symbol is known as a resource element (RE). Each RE is used to transmit a particular number of bits, depending on the type of modulation and/or bit-mapping constellation used for that RE. For example, some REs may carry two bits using QPSK modulation, while other REs may carry four or six bits using 16- or 64-QAM, respectively. The radio resources of the LTE PHY are also defined in terms of physical resource blocks (PRBs). A PRB spans N^{RB}_{sc} sub-carriers over the duration of a slot (i.e., N^{DL}_{symb} symbols), where N^{RB}_{sc} is typically either 12. (with a sub-carrier bandwidth of 15 kHz) or 24 (with a sub-carrier bandwidth of 7.5 kHz). A PRB spanning the same N^{RB}_{sc} subcarriers during an entire subframe (i.e., 2N^{DL}_{symb} symbols) is known as a PRB pair. Accordingly, the resources available in a subframe of the LTE PHY downlink comprise N^{DL}_{RB} PRB pairs, each of which comprises 2N^{DL}_{symb}·N^{RB}_{sc} REs. For a normal CP and 15-KHz sub-carrier bandwidth, a PRB pair comprises 168 REs.

One characteristic of PRBs is that consecutively numbered PRBs (e.g., PRBᵢ and PRBᵢ₊₁) comprise consecutive blocks of subcarriers. For example, with a normal CP and 15-KHz sub-carrier bandwidth, PRB₀ comprises sub-carrier 0 through 11 while PRB₁ comprises sub-carries 12 through 23. The LTE PHY resource also can be defined in terms of virtual resource blocks (VRBs), which are the same size as PRBs but may be of either a localized or a distributed type. Localized VRBs are mapped directly to PRBs such that VRB n_{VRB} corresponds to PRB n_{PRB}=n_{VRB}. On the other hand, distributed VRBs may be mapped to non-consecutive PRBs according to various rules, as described in 3GPP Technical Specification (TS) 36.213 or otherwise known to persons of ordinary skill in the art. However, the term “PRB” will be used in this disclosure to refer to both physical and virtual resource blocks. Moreover, the term “PRB” will be used henceforth to refer to a resource block for the duration of a subframe, i.e., a PRB pair, unless otherwise specified.

As mentioned above, the LTE PHY maps the various downlink physical channels to the resources shown in FIG. 3. For example, the PDCCH carries scheduling assignments and other control information. A physical control channel is transmitted on an aggregation of one or several consecutive control channel elements (CCEs), and a CCE is mapped to the physical resource shown in FIG. 3 based on resource element groups (REGs), each of which is comprised of a plurality of REs. For example, a CCE may be comprised of nine (9) REGs, each of which is comprised of four (4) REs. The transmission level of a physical channel, is specified in terms of energy per resource element (EPRE), the average energy of all REs comprising the physical channel (e.g., PDSCH or PDCCH).

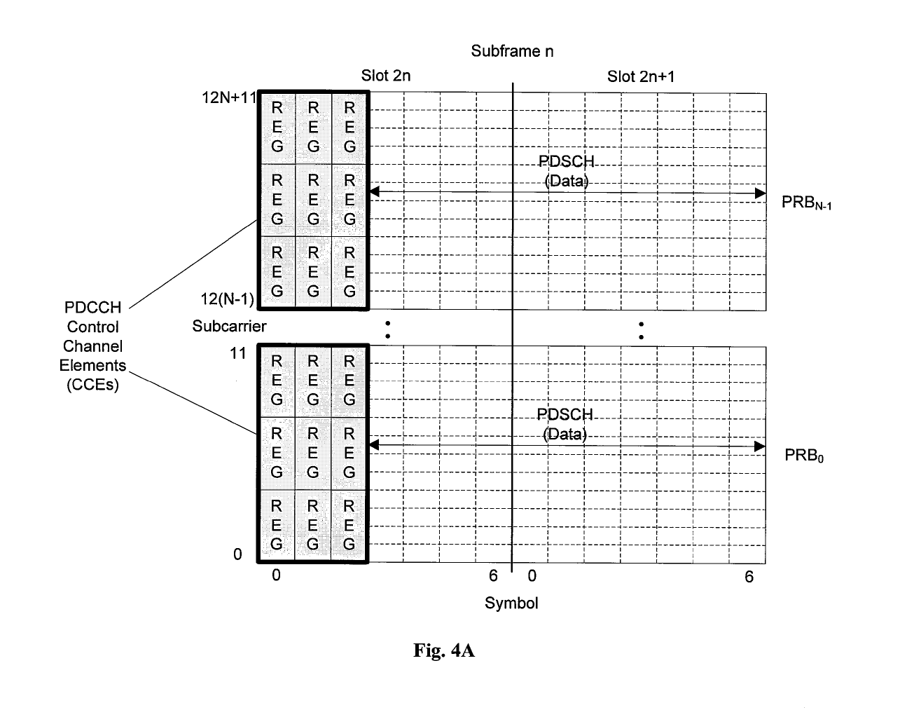

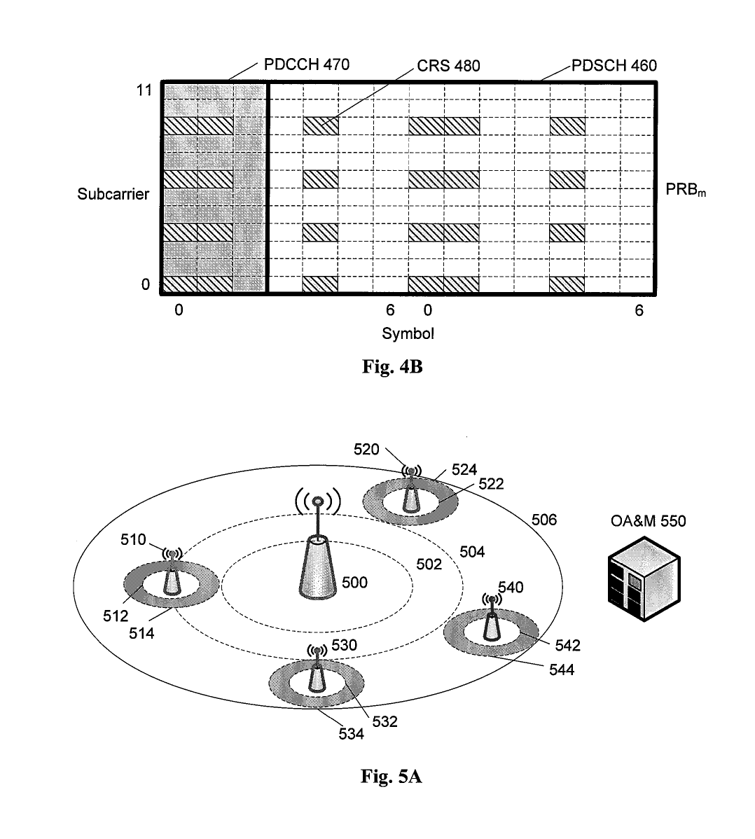

FIG. 4A illustrates one manner in which the CCEs and REGs can be mapped to the physical resource, i.e., PRBs. As shown in FIG. 4A, the REGs comprising the CCEs of the PDCCH may be mapped into the first three symbols of a subframe, whereas the remaining symbols are available for other physical channels, such as the PDSCH which carries user data. Each of the REGs comprises four REs, which are represented by the small, dashed-line rectangles. Since QPSK modulation is used for the PDCCH, in the exemplary configuration of FIG. 4A, each REG comprises eight (8) bits and each CCE comprises 72 bits. Although two CCEs are shown in FIG. 4A, the number of CCEs may vary depending on the required PDCCH capacity, determined by number of users, amount of measurements and/or control signaling, etc. Moreover, other ways of mapping REGs to CCEs will be apparent to those of ordinary skill in the art.

Various downlink reference signals are defined in Release 11, and each comprises a particular set of predetermined information that is known by the UE and used by UE for a particular purpose. Cell-specific reference signals (CRS) are transmitted to all UEs in a particular cell and, as defined in Release 11, are included in every downlink PRB of every subframe. CRS are embedded into the downlink signal at particular REs whose pattern is determined based on the cell's identity and other information. FIG. 4B shows an exemplary downlink PRB comprising a plurality of PDSCH REs 460, a plurality of PDCCH REs 470, and exemplary pattern of CRS REs 470. CRS are used by UEs for searching and initial acquisition of cells, for downlink channel estimation used in coherent demodulation and/or detection of data-bearing signals, and for downlink channel quality measurements. Due to their importance, CRS have a constant EPRE specific to each cell that is indicated in the cell's broadcast System Information message. Furthermore, the CRS EPRE is the highest among all components of the downlink signal for each cell, and the power levels of all other signal components (e.g., synchronization, PBCH, PCFICH, PDCCH, PDSCH, etc.) are specified relative to the CRS EPRE.

Global mobile data traffic has tripled each year since 2008 and it is projected to increase 26-fold between 2010 and 2015. To address this exponential growth in demand, cellular operators are aggressively overlaying smaller cells (also known as “pico cells”) on top of existing macro cells. Pico cell eNBs (peNBs) are typically deployed by network operators in wireless hotspot areas (e.g., malls) and provide access to all users, albeit with transmit power typically an order of magnitude less than macro cell eNBs (meNBs). The combined macro cell/pico cell topology is known in 3GPP parlance as a heterogeneous network or “hetnet.” Users with poor coverage at the edge of macro cells can be offloaded to an overlaid pico cell, where they will receive a higher quality of service. Because of the relative proximity of users and the reduced transmit power of peNBs, more users can receive a given quality of service within the same area in a hetnet compared to a conventional network consisting only of meNBs. This is commonly known as a “cell-splitting” gain.

Since both the macro cell and overlaid pico cells transmit in the same radio frequency spectrum in the same geographic area, one negative consequence of the hetnet topology is that users may experience severe inter-cell interference, also known as the “loud neighbor effect.” This is particularly problematic for users who are served by a peNB but located near the edge of the pico cell's coverage area, where in certain situations the strength of the co-channel interference from the meNB may be greater than the strength of the desired signal from the peNB. 3GPP— has devoted significant standardization effort towards devising inter-cell interference coordination (ICIC) schemes for minimizing such interference.

Although the hetnet topology provides the network operator the ability to offload certain UEs from macro cells to overlaid pico cells, the achievable cell-splitting gain is limited by the relatively small coverage area of the pico cells, which in turn limits the number of UEs that can receive each peNB signal. 3GPP Release 10 improves this by providing for cell range expansion (CRE) of pico cells. In this scheme, the network biases pico cell reference signal received power (RSRP) reported by UEs such that UEs in an overlapping meNB/peNB coverage area are more likely to be handed over to from the meNB to the peNB even when the actual peNB signal is weaker than the meNB signal. Although CRE enables higher user offloading from macro cells to pico cells, different problems can arise due to the fact that the UE's serving peNB is not the strongest cell. The UEs connecting to the so-called “victim” peNB can suffer from severe interference from the “aggressor” meNB, particularly when large CRE bias is utilized by the network for cell selection.

In a hetnet, a combination of enhanced inter-cell interference coordination (eICIC) and CRE is effective for improving the system and cell edge throughput. With eICIC, a meNB mitigates interference to UEs in a peNB's CRE coverage area by transmitting so-called “almost blank subframes” (ABS) in which the Physical Downlink Control Channel (PDCCH) and/or the Physical Downlink Shared Channel (PDSCH) have a zero power level. However, System Information and some physical-layer signals (e.g., CRS) are still transmitted in an ABS to ensure backward compatibility with legacy UEs. More recently, as described below, an enhanced ABS scheme known as low-power ABS (LP-ABS) has been proposed to improve utilization of the shared frequency spectrum in a hetnet. A UE served uses the protected resources in the signal transmitted by the victim cell for cell measurements (RRM), radio link monitoring (RLM), and channel-state information (CSI) measurements. These UE measurements are restricted to specific subframe patterns—called “measurement resource restrictions”—derived from the pattern of ABS (or LP-ABS, as the case may be) and signaled to the UE by the serving eNB. The particular measurement resource restriction depends on the type of measured cell (e.g., serving or neighbor cell) and measurement (e.g. RRM, RLM, or CSI).

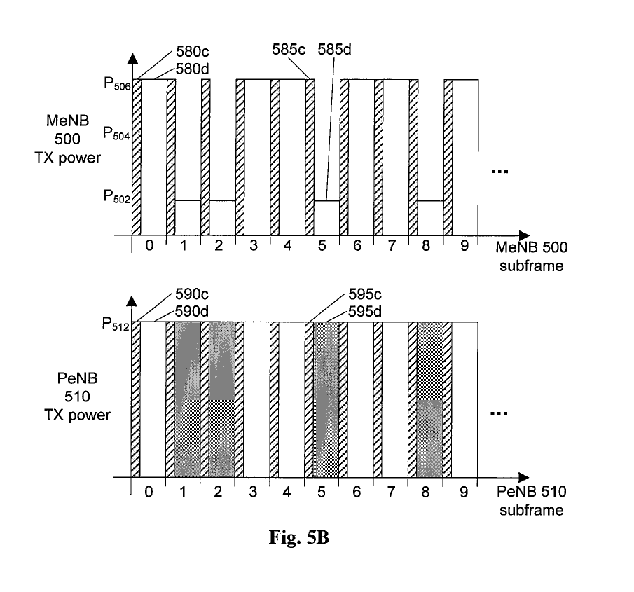

FIG. 5A shows an exemplary hetnet comprising a meNB 500 and peNBs 510, 520, 530, and 540. meNB 500 is capable of communicating with each of peNBs 520, 530, and 540, e.g., via the via the standardized X2 interface shown in FIG. 1 and described above. The hetnet of FIG. 5A also comprises an operations, administration, and maintenance (OA&M) server 550, which is connected to each of the eNBs 500 through 540 either directly or via one or more intermediate nodes, servers, systems, etc. meNB 500 is configured to transmit at three different power levels, corresponding respectively to coverage areas 502, 504, and 506. As understood by persons of ordinary skill in the art, a “coverage area” is the geographic region in which the energy of the desired signal received from the serving eNB is acceptable in relation to the combination of the UE's receiver noise and the power of interfering signals received from other eNBs, i.e., the signal-to-interference-and-noise ratio (SINR). Each of the peNBs is configured to transmit at a single power level that corresponds to two different pico cell coverage areas—one normal coverage area and one CRE coverage area. As described above, the CRE area is the geographic region in which UEs will be handed over to be served by an peNB, even though the actual received peNB signal level (or SINR) is less than the actual received meNB signal level (or SINR). For example, peNB 510 is configured to transmit at power corresponding to normal coverage area 512 and CRE coverage area 514.

FIG. 5B illustrates the use of ABS in conjunction with the network topology shown in FIG. 5A. The top portion of FIG. 5B shows selective transmission of ABS by meNB 500 within a single frame of 10 subframes, labeled “0” through “9” on the horizontal axis. In each subframe, meNB 500 selectively transmits control and/or data channels, e.g., PDSCH and/or PDCCH, at either full power level P₅₀₆ that corresponds to full coverage area 506 shown in FIG. 5A, or at ABS power level P₅₀₂ that corresponds to reduced coverage area 502. In some embodiments, ABS power level P₅₀₂ may be zero. As understood by persons of ordinary skill in the art, when choosing to transmit at ABS power level P₅₀₂ rather than full power level P₅₀₆, meNB 500 chooses to utilize its resources of transmission power and frequency spectrum less efficiently, albeit in favor of usage of the same resources by peNBs 510, 520, 530, and 540.

In each subframe, meNB 500 also transmits a reference signal at full power level P₅₀₆ that corresponds to full coverage area 506. The reference signal may comprise, for example, cell-specific reference signals (CRS) used by legacy UEs for various purposes as known by persons of ordinary skill in the art. For example, in subframe 0, meNB 500 transmits signal 580d comprising one or more of PDSCH and/or PDCCH and signal 580c comprising CRS. Both are transmitted at full power level P₅₀₆. meNB 500 transmits according to the same configuration in subframes 3-4, 6-7, and 9. Alternately, in subframe 5, meNB 500 transmits signal 585d comprising one or more of PDSCH and/or PDCCH at ABS power level P₅₀₂ and signal 585c comprising CRS at full power level P₅₀₆. meNB 500 transmits using the same ABS configuration in subframes 1-2 and 8.

The operation of the peNBs in the network of FIG. 5A is illustrated by the bottom portion of FIG. 5B. This portion shows the transmissions of peNB 510 within a single frame of 10 subframes, labeled “0” through “9” on the horizontal axis. In each subframe, peNB 510 transmits control and/or data channels, e.g., PDSCH and/or PDCCH, at power level P₅₁₂ that corresponds to normal coverage area 512. Moreover, peNB 510's transmissions at power level P₅₁₂ are also used for communication with UEs located in coverage area 514 when meNB 500 utilizes RSRP measurement bias for CRE of peNB 510, as described above. Accordingly, coverage area 514 will be referred to hereinafter as “CRE coverage area 514,” and the same nomenclature used for the expanded coverage areas of peNBs 520, 530, and 540 in FIG. 5A. In each subframe, peNB 510 also transmits a reference signal at power level P₅₁₂. For example, in subframe 0, peNB 510 transmits control and data channels 590d and reference signal 590c.

peNB 510 selectively transmits each subframe to a UE located in either peNB 510's normal coverage area 512 or CRE coverage area 514, as shown in FIG. 5A, based on the power level of the transmissions by meNB 500 in that same subframe. For example, since meNB 500 transmits subframes 0, 3-4, 6-7, and 9 at full power level P₅₀₆, peNB 510 must transmit these subframes to a UE located in normal coverage area 512 in order to provide an acceptable SINR for that UE. On the other hand, since meNB 500 transmits subframes 1-2, 5, and 8 at ABS power level P₅₀₂, peNB 510 may transmit these subframes to a UE located either in normal coverage area 512 or in CRE coverage area 514. Since peNB 510 may transmit PDSCH and/or PDCCH to UEs located in CRE coverage area 514 only in subframes 1-2, 5, and 8 (i.e., the shaded portions in FIG. 5B), it may prioritize transmissions to UEs located in CRE coverage area 514 in these particular subframes. peNBs 520, 530, and 540 may behave in the same manner with respect to UEs located in their respective normal and CRE coverage areas.

Although the arrangement illustrated by FIGS. 5A and 5B provides the network operator with the flexibility to offload UEs from macro cells to pico cells, it does not utilize the scarce resources of transmission power and frequency spectrum in the most efficient manner. In particular, although reduced ABS power level P₅₀₂ is needed to achieve adequate SINR for UEs served by peNB 510, it provides greater than adequate SINR for UEs served by peNBs 520, 530, and 540. In other words, since peNBs 520, 530, and 530 are further away from meNB 500 than peNB 510, meNB 500 can transmit at a higher power level, e.g., P₅₀₄, and still provide adequate SINR for UEs served by peNBs 520, 530, and 540. By transmitting at a lower power level than necessary for adequate SINR in the pico cells, meNB 500 is effectively underutilizing its transmission power and frequency spectrum resources. To this end, 3GPP Release 12 will include an enhanced ICIC (eICIC) scheme known as low-power ABS (“LP-ABS”, also known as “reduced-power ABS” or “non-zero-power ABS”), in which a macro cell eNB can transmit at a plurality of reduced power levels according to the various needs of the pico cell eNBs with CRE that are overlaid within its coverage area. Unlike conventional ABS, where the macrocell may cease transmission of PDCCH/PDSCH in certain subframes in favor of the overlaid pico cells, the macro cell eNB can utilize the LP-ABS resources to communicate with UEs located within its nearby coverage area (e.g., cell center), while at the same time allowing overlaid pico cell eNBs to communicate with UEs located in their respective CRE coverage areas with acceptable interference levels. This feature improves the utilization of the frequency spectrum resources shared among macro cells and pico cells in a hetnet.

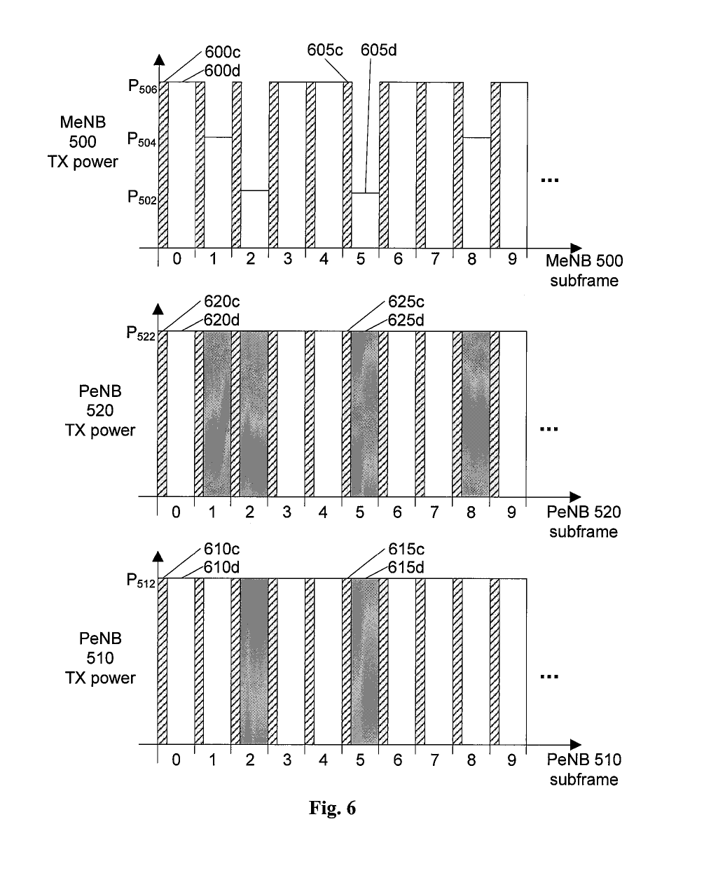

The use of LP-ABS with CRE in conjunction with the network topology of FIG. 5A is illustrated by FIG. 6. The top portion of FIG. 6 shows selective transmission of LP-ABS by meNB 500 within a single frame of 10 subframes, labeled “0” through “9” on the horizontal axis. In each subframe, meNB 500 selectively transmits control and/or data channels (e.g., PDSCH and/or PDCCH) at either power level P₅₀₆ that corresponds to full coverage area 506, at LP-ABS power level P₅₀₄ that corresponds to reduced coverage area 504, or at LP-ABS power level P₅₀₂ that corresponds to reduced coverage area 502. In each subframe, meNB 500 also transmits a reference signal at full power level P₅₀₆ that corresponds to full coverage area 506. The reference signal may comprise, for example, cell-specific reference signals (CRS). In the exemplary frame shown in FIG. 6, meNB 500 transmits at power level P₅₀₆ in subframes 0, 3-4, 6-7, and 9; at LP-ABS power level P₅₀₄ in subframes 1 and 8; and at LP-ABS power level P502 in subframes 2 and 5.

The middle and bottom portions of FIG. 6 illustrates the operation of peNBs 520 and 510, respectively, that employ CRE in conjunction with the LP-ABS transmitted by meNB 510. Each of peNBs 510 and 520 selectively transmits each subframe to a UE located in either the peNB's normal coverage area (e.g., coverage area 522 for peNB 520) or in the peNB's CRE coverage area (e.g., coverage area 524 for peNB 520) based on the power level of the transmissions by meNB 500 in that same subframe. For example, since meNB 500 transmits subframes 0, 3-4, 6-7, and 9 at full power level P₅₀₆, peNBs 510 and 520 must transmit these subframes to UEs located in their respective normal coverage areas 512 and 522, respectively, in order to provide an acceptable SINR for those UE.

By the same token, since meNB 500 transmits subframes 1 and 8 at LP-ABS power level P₅₀₄, peNB 510 must transmit these subframes to UEs located in its normal coverage area 512 in order to provide an acceptable SINR for those UE. Since peNB 520 is located further away from meNB 500 than peNB 510 (i.e., in meNB 500 coverage area 506 rather than coverage area 504), peNB 520 may selectively transmit PDSCH and/or PDCCH in subframes 1 and 5 to UEs located in either in normal coverage area 522 or in CRE coverage area 524. On the other hand, since meNB 500 transmits subframes 2 and 5 at LP-ABS power level P₅₀₂, both peNB 510 and pENB 520 must transmit these subframes to UEs located in their respective CRE coverage areas 514 and 524 in order to provide an acceptable SINR for those UEs. The shaded portions of FIG. 6 indicate subframes in which peNBs 510 and 520 may transmit PDSCH and/or PDCCH traffic to UEs located in their respective CRE coverage areas 514 and 524, such that these UEs can receive the traffic with acceptable SINR.

meNB 500 can set the various LP-ABS power levels it uses based upon relevant information for the hetnet environment, including the locations and CRE bias values for the respective peNBs. Although FIG. 6 shows usage of two LP-ABS levels, this is merely exemplary and in practice a meNB may utilize more than two LP-ABS levels according to the relevant information concerning the overlaid pico cells in the hetnet environment. In this manner, the meNB can make a reasonable tradeoff between the protection for the peNBs and the resource utilization efficiency of the meNB.

Although the use of multi-level LP-ABS together with pico cell CRE improves the utilization of the transmission power and frequency spectrum resources in the hetnet environment, it creates other difficulties for UEs served by peNBs in the hetnet. For example, certain UEs may be capable of mitigating the interference from the meNB transmissions by partially or entirely cancelling the meNB CRS, thereby enabling these UEs to more accurately perform the CSI measurement and RRM measurement for one or more of the peNBs in the hetnet. Accurate RRM and CSI measurements are necessary, for example, during UE handover from a meNB to a peNB, from a peNB to a meNB, or between peNBs. CRS interference cancellation may be necessary to achieve accurate CSI and RRM measurements in cases where one or more reference signals (e.g., CRS of one or more peNBs) overlap in time with CRS in an interfering signal (e.g., meNB CRS). This is particularly true when the interfering meNB signal also comprises one or more ABS, as shown in FIGS. 5B and 6.

However, meNB transmissions in which all subframes comprise full-power CRS but each subframe may utilize one of a plurality of LP-ABS levels for PDSCH and/or PDCCH signals (as shown in FIG. 6) can affect the ability of these UEs to cancel the meNB CRS interference. The resulting inaccurate RRM and CSI measurements may cause improper handover operation and channel estimation, among other problems. Accordingly, there is a need to configure UEs operating in a victim cell (e.g., pico cell) in a hetnet environment with information about the aggressor cell (e.g., macro cell) LP-ABS configuration that enables them to mitigate CRS interference when making CSI measurements. Meanwhile, there is also a need to configure UEs operating in an aggressor cell (e.g., a macro cell) and approaching a victim cell (e.g., a pico cell) with information about the aggressor cell LP-ABS configuration that enables them to mitigate CRS interference when making RRM measurements.

Embodiments of the present disclosure solve these and other problems by methods for providing information that enables a communication device (e.g., a UE), operating in a heterogeneous network (hetnet) comprised of an aggressor cell (e.g., meNB) and one of more victim cells (e.g., peNBs) that are subject to co-channel interference from the aggressor cell, to at least partially cancel an interfering reference signal (e.g., CRS) transmitted by the aggressor cell in order to more accurately measure one or more characteristics of the communication paths or channels (e.g., CSI or RRM) between one or more of the victim cells and the device. Other embodiments include network equipment or apparatus (e.g., OA&M server or eNB), user equipment or apparatus (e.g., UEs), and computer-readable media embodying one or more of these methods.

Embodiments of the present disclosure also include methods for a network equipment or apparatus to configure a wireless network comprising a first cell and plurality of second cells utilizing a common frequency spectrum, wherein the coverage area for the first cell substantially comprises the coverage areas for the second cells. In some embodiments, these methods comprise receiving information related to first cell and the plurality of second cells; determining, for each particular cell of the plurality of second cells, a level of interference from the first cell that is sustainable for operation of the particular cell based on the received information; and configuring the first cell with the determined levels of interference corresponding to the plurality of second cells. In some embodiments, the first cell is a macro cell and the second cells are pico cells. In some embodiments, the information related to the first cell and plurality of second cells comprises one or more of the geographic location for each of the respective cells and the cell range expansion (CRE) for each of the plurality of second cells. Other embodiments include network equipment or apparatus (e.g., OA&M server) and computer-readable media embodying one or more of these methods.

Embodiments of the present disclosure also include methods for a network equipment or apparatus to configure a wireless network comprising a first cell and plurality of second cells utilizing a common frequency spectrum, wherein the coverage area for the first cell substantially comprises the coverage areas for the second cells. In some embodiments, these methods comprise receiving a message comprising sustainable levels of interference for each of the plurality of second cells; determining a transmission pattern for the first cell based at least in part on the sustainable levels of interference for each of the plurality of second cells, wherein the transmission pattern comprises the transmit power levels for a physical-layer (PHY) signal in a plurality of subframes; for each interference level represented within the received message, determining one or more measurement parameters related to the transmission pattern for the first cell; and configuring each of the plurality of second cells with the measurement parameters determined for the interference level corresponding to that particular cell. In some embodiments, the first cell is a macro cell and the plurality of second cells are pico cells. In some embodiments, the wireless network comprises an Evolved UMTS Terrestrial Radio Access Network (E-UTRAN); the PHY signal comprises at least one of a Physical Downlink Shared Channel (PDSCH) and a Physical Downlink Control Channel (PDCCH); and configuring a second cell comprises sending a message to the evolved Node B (eNB) serving the second cell's coverage area over the X2 interface. In some embodiments, the transmission pattern comprises a plurality of different non-zero transmit power levels for the PHY signal in the plurality of subframes, wherein the plurality of different non-zero transmit power levels comprises a plurality of LP-ABS power levels for the PHY signal. Other embodiments include network equipment or apparatus (e.g., eNB) and computer-readable media embodying one or more of these methods.

Embodiments of the present disclosure also include methods for a network equipment or apparatus to determine whether to hand over a communication device from a first cell to a second cell in a wireless network, wherein the first and second cells utilize a common frequency spectrum and the coverage area for the first cell substantially comprises the coverage area for the second cell. In some embodiments, the methods comprise determining that the device is proximate to the coverage area for the second cell; determining a sustainable interference level for the second cell; determining one or more measurement parameters for the second cell based on the transmission pattern for the first cell and the sustainable interference level for the second cell, wherein the transmission pattern comprises the transmit power levels for a PHY signal in a plurality of subframes; configuring the device with the measurement parameters; and receiving, from the device, measurements made on a signal transmitted from the second cell according to the measurement parameters. In some embodiments, the first cell is a macro cell and the plurality of second cells are pico cells. In some embodiments, the wireless network comprises an E-UTRAN; the PHY signal comprises at least one of a PDSCH and a PDCCH; and configuring a second cell comprises sending a message to the eNB serving the second cell's coverage area over the X2 interface. In some embodiments, the transmission pattern comprises a plurality of different non-zero transmit power levels for the PHY signal in the plurality of subframes, wherein the plurality of different non-zero transmit power levels comprises a plurality of LP-ABS power levels for the PHY signal. Other embodiments include network equipment or apparatus (e.g., eNB) and computer-readable media embodying one or more of these methods.

Embodiments of the present disclosure also include methods for a network equipment or apparatus to receive measurements of a signal transmitted by a second cell in a wireless network, wherein the wireless network also comprises a first cell that substantially comprises the coverage area for the second cell and the first and second cells utilize a common frequency spectrum. In some embodiments, the methods comprise receiving one or more measurement parameters related to transmission pattern for the first cell and the sustainable interference level for the second cell, wherein the transmission pattern comprises the transmit power levels for a PHY signal in a plurality of subframes; determining that a device in communication with the second cell is proximate to the coverage area of the second cell; configuring the device with the measurement parameters; and receiving measurements made by the device on a signal transmitted from the second cell according to the measurement parameters. In some embodiments, the measurement parameters comprise a measurement subset of subframes and a parameter characterizing the transmit power level of the PHY signal during the subframes of the measurement subset. In some embodiments, the parameter characterizing the transmit power level is one of the absolute power level of the PHY signal during the subframes of the measurement subset and the power level of the PHY signal during the subframes of the measurement subset relative to the power level of a second PHY signal transmitted during the subframes of the measurement subset. In some embodiments, the second PHY signal is a cell-specific reference signal. In some embodiments, the measurements comprise CSI measurements. Other embodiments include network equipment or apparatus (e.g., eNB) and computer-readable media embodying one or more of these methods.

Embodiments of the present disclosure also include methods for a user equipment (UE) or apparatus to make measurements on a signal transmitted by a second cell in a wireless network, wherein the wireless network also comprises a first cell that substantially comprises the coverage area for the second cell and the first and second cells utilize a common frequency spectrum. In some embodiments, the methods comprise receiving a message comprising one or more measurement parameters related to a transmission pattern for the first cell and a sustainable interference level for the second cell, wherein the transmission pattern comprises the transmit power levels for a PHY signal in a plurality of subframes; measuring one or more parameters of a signal transmitted by the second cell according to the received measurement parameters; and sending a message comprising the measured signal parameters. In some embodiments, the first cell is a macro cell and the second cell is a pico cell. In some embodiments, the measured one or more parameters comprise at least one of RRM measurements and CSI measurements. In some embodiments, measuring one or more parameters of a signal transmitted by the second cell according to the received measurement parameters comprises measuring the one or more parameters during the subframes of the measurement subset; and utilizing the parameter characterizing the transmit power to at least partially cancel CRS interference during the measurement. Other embodiments include user equipment or apparatus (e.g., UE) and computer-readable media embodying one or more of these methods.

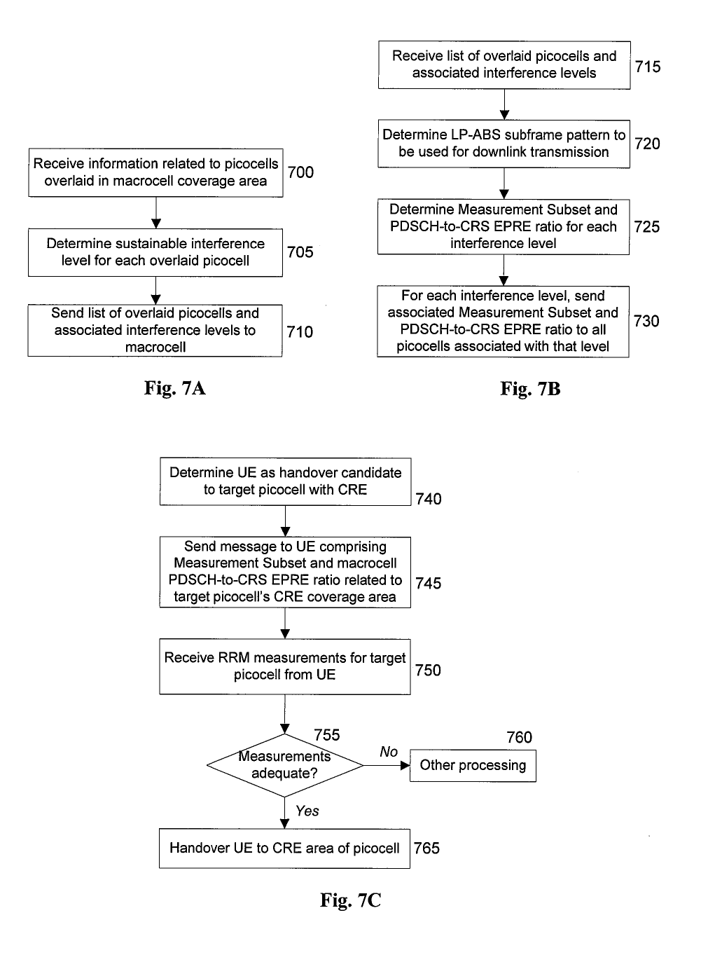

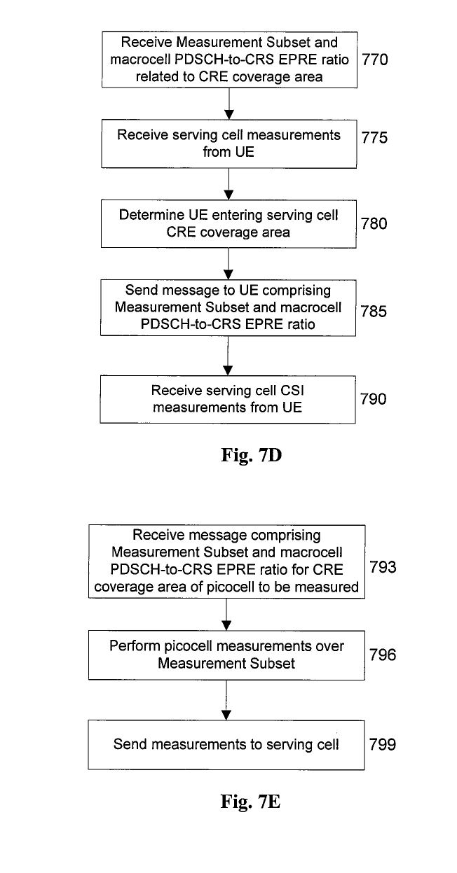

FIG. 7A is a flowchart of a communication method according to one or more embodiments of the present disclosure. While the communication method of FIG. 7A is described in terms of being performed by an OA&M server with respect to a macro cell eNB (meNB), in some embodiments it may be performed by other network equipment that is communicatively coupled to the meNB. Although the method is illustrated by blocks in the particular order of FIG. 7A, this order is merely exemplary and the steps of the method may be performed in a different order than shown by FIG. 7A, and may be combined and/or divided into blocks having different functionality.

In block 700, the server receives information related to one or more pico cells (i.e., peNBs) deployed within a coverage area of the meNB. This information may comprise, for example, the respective locations of the peNBs relative to the meNB, the respective CRE bias values for the peNBs, etc. The server may receive this information in various ways such as, for example, downloading it from a database, manual entry by an operator via a user interface device such as a keyboard, and other ways known to persons of ordinary skill in the art. In block 705, the server determines a sustainable interference level for each of the overlaid pico cells within the macro cell coverage area. The determined sustainable interference level for a pico cell may be selected from one of a plurality of enumerated levels, e.g., level 1, level 2, etc., based on the relative locations of the peNB and the meNB and the size and/or bias value for the peNB's CRE coverage area. For example, based on received information related to the hetnet shown in FIG. 5A, the server may determine “level 2” for peNB 510 that is closest to meNB 500 and “level 1” for peNBs 520, 530, and 540 that are more distant from meNB 500. Note that the choice of two levels is merely exemplary and additional levels may be used within the scope of the present disclosure. In block 710, the server sends the list of overlaid pico cells and their associated interference levels determined in block 705 to the macro cell (e.g. meNB 500) using appropriate signaling protocols.

FIG. 7B is a flowchart of a communication method according to one or more other embodiments of the present disclosure. While the communication method of FIG. 7B is described in terms of being performed by a macro cell eNB (meNB) with respect to a one or more overlaid pico cell eNBs (peNBs), in some embodiments it may be performed by other network equipment that is communicatively coupled to the peNBs. Although the method is illustrated by blocks in the particular order of FIG. 7B, this order is merely exemplary and the steps of the method may be performed in a different order than shown by FIG. 7B, and may be combined and/or divided into blocks having different functionality.

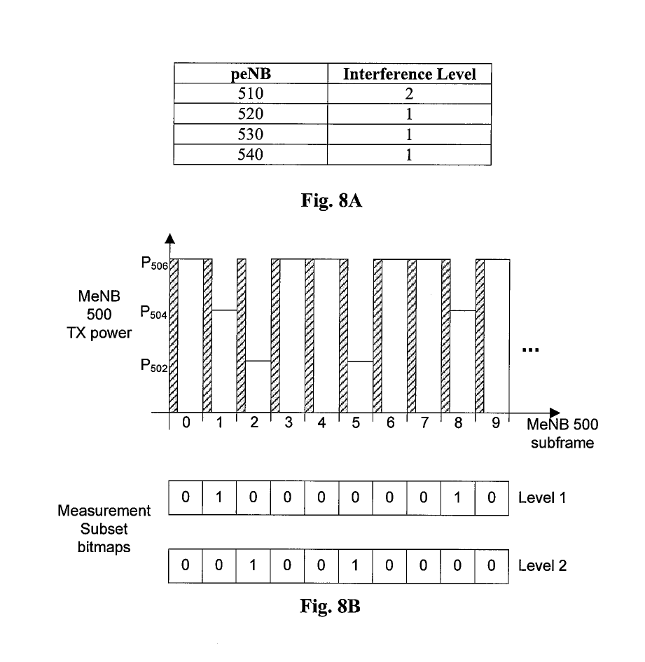

In block 715, the meNB receives a list of pico cells (e.g., peNBs) overlaid within its coverage area and a sustainable interference level associated with each peNB. More particularly, the sustainable interference level may be associated with the peNB's CRE coverage area. FIG. 8A shows an exemplary table relating peNBs to interference levels corresponding to the hetnet topology shown in FIG. 5A; which would be received by meNB 500 according to the operation of block 715. In block 720, the meNB determines an LP-ABS subframe pattern to use for downlink transmission of control and/or data channels, e.g., PDSCH. This may be determined, for example, based on the current or expected downlink data traffic for UEs served by the meNB, the number of overlaid peNBs and their respective interference levels, the current or expected amount of downlink traffic within the overlaid peNBs, and other factors. By way of example, for the hetnet topology shown in FIG. 5A, the meNB may determine to transmit PDSCH traffic using the LP-ABS pattern shown in FIG. 6, i.e., six subframes transmitted at full power and two each transmitted at lower power levels.

In block 725, the meNB determines a Measurement Subset for each of the interference levels to which one of the peNBs in the meNB coverage area is assigned. The Measurement Subset may be determined, for example, to comprise the subframes within the LP-ABS pattern transmitted by the meNB during which a UE in a peNB's CRE coverage area can receive the peNB transmissions at an acceptable SINR. FIG. 8B shows the meNB LP-ABS pattern from FIG. 6 and exemplary Measurement Subsets determined for interference levels 1 and 2, respectively, from this pattern. The Measurement Subsets shown in FIG. 8B are in the form of bitmaps, with the values directly below each subframe indicating whether pico cell CSI and/or RRM measurements should be made during that subframe. For example, under subframe 1, a “1” in the level-1 bitmap and “0” in the level-2 bitmap indicate that CSI and/or RRM measurements may be made during subframe 1 for pico cells associated with level 1 (e.g., peNBs 520, 530, and 540 based on FIG. 8A) but not for pico cells associated with level 2 (e.g., peNB 510). Likewise, a “1” in the level-2 bitmap and “0” in the level-1 bitmap indicate that CSI and/or RRM measurements may be made during subframe 1 for pico cells associated with level 2 but not for pico cells associated with level 1. The bitmap format shown in FIG. 8B is merely exemplary, however, and the Measurement Subset may be specified in other formats including a list of one or more subframe numbers during which CSI and/or RRM measurements for a pico cell associated with a particular level are required or prohibited.

In block 725, the meNB also determines a PDSCH-to-CRS EPRE ratio for each of the interference levels to which one of the peNBs in the meNB coverage area is assigned. For example, based on the meNB LP-ABS pattern shown in FIG. 8B, the PDSCH-to-CRS EPRE ratios for levels 1 and 2 may be determined as P₅₀₄/P₅₀₆ and P₅₀₂/P₅₀₆, respectively. Persons of ordinary skill also will understand that these ratios may be scaled as necessary. In block 730, the meNB sends the appropriate Measurement Subset and PDSCH-to-CRS EPRE ratio to each peNB in the macro cell coverage area, according to the interference level associated with that particular peNB. For example, in relation to the hetnet shown in FIG. 5A, meNB 500 sends the Measurement Subset and PDSCH-to-CRS EPRE ratio associated with level 1 to peNBs 520, 530, and 540, and sends the Measurement Subset and PDSCH-to-CRS EPRE ratio associated with level 2 to peNB 510, based on information received in block 715. Alternately, rather than sending the PDSCH-to-CRS EPRE ratio associated with a particular level, the meNB may send the non-normalized PDSCH EPRE value.

FIG. 7C is a flowchart of a communication method according to one or more other embodiments of the present disclosure. While the communication method of FIG. 7C is described in terms of being performed by a macro cell eNB (meNB) with respect to a device (UE) being served by the meNB, in some embodiments it may be performed by other network equipment communicatively coupled to the UE, such as a peNB or other type of eNB. Although the method is illustrated by blocks in the particular order of FIG. 7C, this order is merely exemplary and the steps may be performed in a different order than shown by FIG. 7C, and may be combined and/or divided into blocks having different functionality.

In block 740, the meNB determines that a UE being served by the meNB is a candidate for a handover to a target pico cell overlaid with the meNB's coverage area. In some embodiments, the target pico cell may have a CRE bias value for increasing the area in which UEs will be handed over into the target pico cell from the macro cell. Accordingly, when a UE is handed over into the target pico cell, it most likely will be handed over into the pico cell's outer edge, which is part of the CRE coverage area. The meNB may determine that the UE is a handover candidate based on measurements made by the UE, the position of the UE relative to the target pico cell, and other factors known to persons of ordinary skill in the art.

In block 745, the meNB sends a message to the UE comprising the Measurement Subset and the meNB's PDSCH-to-CRS EPRE ratio associated with the target pico cell. For example, in the hetnet topology shown in FIG. 5A, if meNB 500 determined in block 740 that a UE was a candidate for handover to peNB 510, it would send the UE a message comprising the Measurement Subset and the PDSCH-to-CRS EPRE ratio for level 1, which is associated with peNB 510 as shown in FIG. 8A. In some embodiments, the message may comprise an RRC message, such as an RRCConnectionReconfiguration message, and the Measurement Subset and the PDSCH-to-CRS EPRE ratio are part of the same or different information elements (IEs) within the RRC message. These fields may constitute an implicit command to measure the target pico cell's RSRP for RRM management during the subframes comprising the Measurement Subset, or the message may include an explicit command to that effect. In some embodiments, the message may comprise additional information such as the identity of the target pico cell.

In block 750, the meNB receives RRM measurements made by the UE on the target pico cell according to the instructions comprising the message sent in the operation of block 745. In block 755, the meNB determines whether the UE should be handed off to the target pico cell based, at least in part, on the RRM measurements received in block 750. If the meNB determines that the UE should be handed off, it proceeds to block 765 where it completes that operation; otherwise, the meNB proceeds to block 760 where it performs other processing.

FIG. 7D is a flowchart of a communication method according to one or more other embodiments of the present disclosure. While the communication method of FIG. 7D is described in terms of being performed by a pico cell eNB (peNB) with respect to a device (UE) being served by the peNB, in some embodiments it may be performed by other network equipment communicatively coupled to the UE, such as a meNB or other type of eNB. Although the method is illustrated by blocks in the particular order of FIG. 7D, this order is merely exemplary and the steps may be performed in a different order than shown by FIG. 7D, and may be combined and/or divided into blocks having different functionality.

In block 770, the peNB receives a message comprising the Measurement Subset and a macro cell's PDSCH-to-CRS EPRE ratio associated with its CRE coverage area. In some embodiments, the message may be sent by an meNB whose coverage area overlaps with the peNB's coverage area. For example, if the method of FIG. 7D was utilized by peNB 510 in the hetnet topology shown in FIG. 5A, the operation of block 770 would comprise receiving a message comprising the Measurement Subset and PDSCH-to-CRS EPRE ratio for level 1, which is associated with peNB 510 as shown in FIG. 8A. In some embodiments, the message may comprise a LoadInformation message sent via appropriate protocols over the X2 interface, and the Measurement Subset and the PDSCH-to-CRS EPRE ratio are part of the same or different information elements (IEs) within the LoadInformation message, such as a CRSInterferenceScalingInformation IE. In some embodiments, the message may comprise a different message within an appropriate protocol between eNBs.

In block 775, the peNB receives serving cell measurements from a UE that it is serving within its coverage area. These serving cell measurements may include, for example, one or more measurements of Reference signal received power (RSRP), which is the linear average of power of the CRS REs; and Reference Signal Received Quality (RSRQ), which is a ratio of RSRP to the signal-strength of the received carrier, which includes desired signal, interference, and noise. The received serving cell measurements may comprise other types of measurements commonly used for radio resource control within a cellular network. In block 780, the peNB determines that the UE is entering the peNB's CRE coverage area, i.e., that it is leaving the non-CRE coverage area. For example, with respect to peNB 510 shown in FIG. 5A, the operation of block 775 may comprise determining that the UE is moving from coverage area 512 to coverage area 514. The peNB may make this determination based on the measurements received in block 775. For example, the peNB may determine that UE is entering the CRE coverage area based on decreasing values of RSRQ.

In block 785, the peNB sends a message to the UE comprising the Measurement Subset and the macro cell PDSCH-to-CRS EPRE ratio associated with the peNB's CRE coverage area, as received in block 770. In some embodiments, the message may comprise an RRC message, such as an RRCConnectionReconfiguration message, and the Measurement Subset and the PDSCH-to-CRS EPRE ratio are part of the same or different information elements (IEs) within the RRC message, such as a CQI-ReportConfig IE. These fields may constitute an implicit command to measure the serving pico cell's CSI during the subframes comprising the Measurement Subset, or the message may include an explicit command to that effect. In block 790, the peNB receives a message from the UE comprising CSI measurements made on the serving pico cell according to the instructions comprising the message sent in the operation of block 785. The peNB may receive multiple CSI measurements made on the serving pico cell, either within a single message or within multiple messages.

FIG. 7E is a flowchart of a communication method according to one or more other embodiments of the present disclosure. While the communication method of FIG. 7E is described in terms of being performed by a device (e.g., UE) with respect to a serving pico cell (e.g., peNB), in some embodiments it may be performed by device with respect to a target pico cell. Although the method is illustrated by blocks in the particular order of FIG. 7E, this order is merely exemplary and the steps may be performed in a different order than shown by FIG. 7E, and may be combined and/or divided into blocks having different functionality.

In block 793, the device receives a message from its serving eNB comprising a Measurement Subset and a macro cell PDSCH-to-CRS EPRE ratio associated with a pico cell's CRE coverage area. In some embodiments, the pico cell associated with the information in the message may be the device's serving pico cell, while in other embodiments, the device's serving cell may be a macro cell and the pico cell may be a handover candidate (i.e., target cell). In some embodiments, the message may comprise additional information such as the identity and/or the type of pico cell. In some embodiments, the message may comprise an RRC message, such as an RRCConnectionReconfiguration message, and the Measurement Subset and the PDSCH-to-CRS EPRE ratio are part of the same or different information elements (IEs) within the RRC message, such as a CQI-ReportConfig IE. Other RRC messages may be used to convey the Measurement Subset and macro cell PDSCH-to-CRS EPRE ratio associated with a pico cell's CRE coverage area. Moreover, these fields may constitute an implicit command to measure the pico cell's CSI and/or RRM information during the subframes comprising the Measurement Subset, or the message may include an explicit command to that effect.

In block 796, the device performs one or more measurements on the pico cell signal during the periods corresponding to the macro cell subframes identified by the Measurement Subset. In some embodiments, the measurements may comprise CSI measurements, while in some embodiments, the measurements may comprise RRM measurements. Moreover, the device uses the received PDSCH-to-CRS EPRE ratio to mitigate the macro cell's CRS interference, resulting in more accurate CSI and/or RRM measurements. Considering the example hetnet topology shown in FIG. 5A, if the device is being served by meNB 500 and receives a message in block 793 relating to peNB 510, the device performs CSI and/or RRM measurements on the signal transmitted by peNB 510 during meNB 500 downlink subframes 2 and 5, as specified by the Level 2 Measurement Subset shown in FIG. 8B. During these measurements, the device utilizes PDSCH-to-CRS EPRE ratio P₅₀₆/P₅₀₂ to cancel the interfering CRS transmitted by meNB 500. By the same token, if the device is being served by meNB 500 and receives a message in block 793 relating to peNB 520, the device performs CSI and/or RRM measurements on the signal transmitted by peNB 520 during meNB 500 downlink subframes 1 and 8, as specified by the Level 1 Measurement Subset shown in FIG. 8B. During these measurements, the device utilizes PDSCH-to-CRS EPRE ratio P₅₀₆/P₅₀₄ to cancel the interfering CRS transmitted by meNB 500. Similarly, if the device is being served by peNB 520 and receives a message in block 793 relating to that cell, the device performs CSI and/or RRM measurements on the signal transmitted by peNB 520 during meNB 500 downlink subframes 1 and 8, during which it utilizes PDSCH-to-CRS EPRE ratio P₅₀₆/P₅₀₄ to cancel the interfering CRS transmitted by meNB 500.

In block 799, the device sends the one or more CSI and/or RRM measurements made in block 796 to its serving cell. In some embodiments, the one or more CSI measurements may comprise an aperiodic CSI report message, which the device sends on a Physical Uplink Control Channel (PUCCH). In other embodiments, the CSI measurements may comprise periodic CSI report messages, which the device sends on a Physical Uplink Shared Channel (PUSCH).

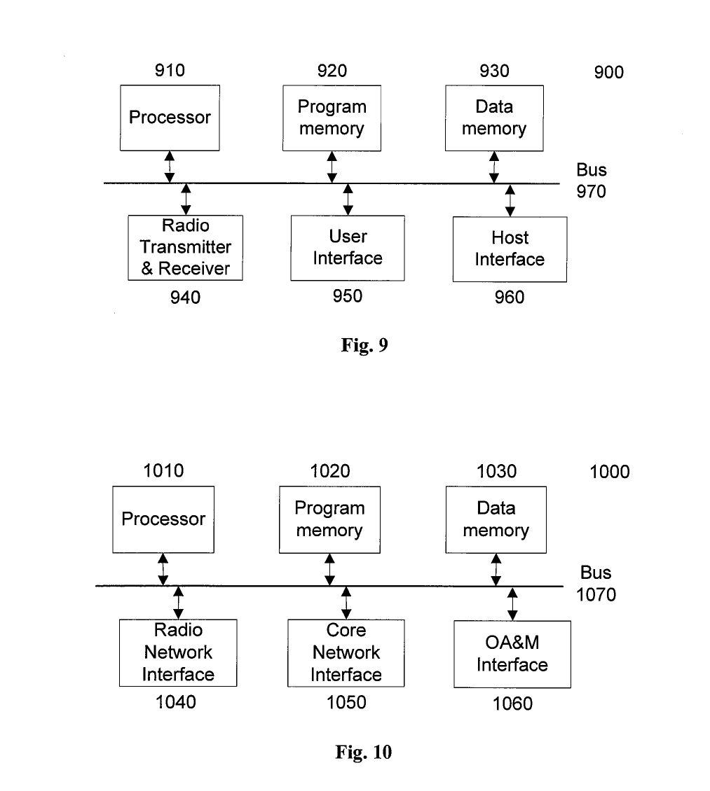

FIG. 9 is a block diagram of exemplary apparatus 900 utilizing certain embodiments of the present disclosure, including one or more of the methods described above with reference to FIGS. 5 through 8. In some embodiments, apparatus 900 comprises a wireless communication device, such as a UE or component of a UE. Apparatus 900 comprises processor 910 which is operably connected to program memory 920 and data memory 930 via bus 970, which may comprise parallel address and data buses, serial ports, or other methods and/or structures known to those of ordinary skill in the art. Program memory 920 comprises software code executed by processor 910 that enables apparatus 900 to communicate with one or more other devices using protocols according to various embodiments of the present disclosure, including the LTE protocols and improvements thereto, including those described above with reference to FIGS. 5 through 8.

Program memory 920 also comprises software code executed by processor 910 that enables apparatus 900 to communicate with one or more other devices using other protocols or protocol layers, such as LTE MAC, RLC, PDCP, and RRC layer protocols standardized by 3GPP, or any improvements thereto; UMTS, HSPA, GSM, GPRS, EDGE, and/or CDMA2000 protocols; Internet protocols such as IP, TCP, UDP, or others known to persons of ordinary skill in the art; or any other protocols utilized in conjunction with radio transceiver 940, user interface 950, and/or host interface 960. Program memory 920 further comprises software code executed by processor 910 to control the functions of apparatus 900, including configuring and controlling various components such as radio transceiver 940, user interface 950, and/or host interface 960. Such software code may be specified or written using any known or future developed programming language, such as e.g. Java, C++, C, and Assembler, as long as the desired functionality, e.g., as defined by the implemented method steps, is preserved. Program memory 920 may comprise non-volatile memory (e.g., flash memory), volatile memory (e.g., static or dynamic RAM), or a combination thereof.

Data memory 930 may comprise memory area for processor 910 to store variables used in protocols, configuration, control, and other functions of apparatus 900, such as the messages transmitted and received in conjunction with the method illustrated by FIG. 7E and described in detail above. Data memory 930 may comprise non-volatile memory, volatile memory, or a combination thereof.

Persons of ordinary skill in the art will recognize that processor 910 may comprise multiple individual processors (not shown), each of which implements a portion of the functionality described above. In such case, multiple individual processors may be commonly connected to program memory 920 and data memory 930 or individually connected to multiple individual program memories and or data memories. More generally, persons of ordinary skill in the art will recognize that various protocols and other functions of apparatus 900 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 940 may comprise radio-frequency transmitter and/or receiver functionality that enables apparatus 900 to communicate with other equipment supporting like wireless communication standards. In an exemplary embodiment, radio transceiver 940 includes an LTE transmitter and receiver that enable apparatus 900 to communicate with various E-UTRANs according to standards promulgated by 3GPP. In some embodiments, radio transceiver 940 includes circuitry, firmware, etc. necessary for apparatus 900 to communicate with network equipment using the LTE PHY protocol layer methods and improvements thereto such as those described above with reference to FIGS. 5 through 8. In some embodiments, radio transceiver 940 includes circuitry, firmware, etc. necessary for apparatus 900 to communicate with various UTRANs and GERANs according to 3GPP standards known to persons of ordinary skill in the art. In some embodiments, radio transceiver 940 includes circuitry, firmware, etc. necessary for apparatus 900 to communicate with various CDMA2000 networks according to 3GPP2 and/or 3GPP standards known to persons of ordinary skill in the art.

In some embodiments, radio transceiver 940 is capable of communicating on a plurality of LTE frequency-division-duplex (FDD) frequency bands 1 through 25, as specified in 3GPP standards. In some embodiments, radio transceiver 940 is capable of communicating on a plurality of LTE time-division-duplex (TDD) frequency bands 33 through 43, as specified in 3GPP standards. In some embodiments, radio transceiver 940 is capable of communicating on a combination of these LTE FDD and TDD bands, as well as other bands specified in the 3GPP standards. In some embodiments, radio transceiver 940 is capable of communicating on one or more unlicensed frequency bands, such as the ISM band in the region of 2.4 GHz. The radio functionality particular to each of these embodiments may be coupled with or controlled by other circuitry in apparatus 900, such as processor 910 executing protocol program code stored in program memory 920.

User interface 950 may take various forms depending on the particular embodiment of apparatus 900. In some embodiments, apparatus 900 is a mobile phone, in which case user interface 950 may comprise a microphone, a loudspeaker, slidable buttons, depressable buttons, a keypad, a keyboard, a display, a touchscreen display, and/or any other user-interface features commonly found on mobile phones. In some embodiments, apparatus 900 may comprise a tablet device, in which case user interface 950 may be primarily—but not strictly limited to—a touchscreen display. In other embodiments, apparatus 900 may be a data modem capable of being utilized with a host device, e.g., a tablet, laptop computer, etc. In such case, apparatus 900 may be fixedly integrated with or may be removably connectable to the host device, such as via a USB port. In these embodiments, user interface 950 may be very simple or may utilize features of the host computing device, such as the host device's display and/or keyboard.

Host interface 960 of apparatus 900 also may take various forms depending on the particular embodiment of apparatus 900. In embodiments where apparatus 900 is a mobile phone or tablet, host interface 960 may comprise a USB interface, an HDMI interface, or the like. In the embodiments where apparatus 900 is a data modem capable of being utilized with a host device, host interface may be a USB or PCMCIA interface.

In some embodiments, apparatus 900 may comprise more functionality than is shown in FIG. 9. In some embodiments, apparatus 900 may also comprise functionality such as a video and/or still-image camera, media player, etc., and radio transceiver 940 may include circuitry necessary to communicate using additional radio-frequency communication standards including GSM, GPRS, EDGE, UMTS, HSPA, CDMA2000, LTE, WiFi, Bluetooth, GPS, and/or others. Persons of ordinary skill in the art will recognize the above list of features and radio-frequency communication standards is merely exemplary and not intended to limit the scope of the present disclosure. Accordingly, processor 910 may execute software code stored in program memory 920 to control such additional functionality.

FIG. 10 is a block diagram of an exemplary apparatus 1000 utilizing certain embodiments of the present disclosure, including those described above with reference to FIGS. 5 through 8. In some embodiments, apparatus 1000 comprises a network equipment such as an eNB (e.g., macro cell or pico cell eNB) or component of an eNB. Apparatus 1000 comprises processor 1010 which is operably connected to program memory 1020 and data memory 1030 via bus 1070, which may comprise parallel address and data buses, serial ports, or other methods and/or structures known to those of ordinary skill in the art. Program memory 1020 comprises software code executed by processor 1010 that enables apparatus 1000 to communicate with one or more other devices, equipment, or apparatus using protocols according to various embodiments of the present disclosure, including the Radio Resource Control (RRC), X2, S1, and improvements thereto.

Program memory 1020 also comprises software code executed by processor 1010 that enables apparatus 1000 to communicate with one or more other devices using other protocols or protocol layers, such as one or more of the PHY, MAC, RLC, PDCP, and RRC layer protocols standardized by 3GPP, or any other higher-layer protocols utilized in conjunction with radio network interface 1040 and core network interface 1050. By way of example and without limitation, core network interface 1050 may comprise the S1 interface and radio network interface 1050 may comprise the Uu interface, as standardized by 3GPP. Program memory 1020 further comprises software code executed by processor 1010 to control the functions of apparatus 1000, including configuring and controlling various components such as radio network interface 1040 and core network interface 1050.

Data memory 1030 may comprise memory area for processor 1010 to store variables used in protocols, configuration, control, and other functions of apparatus 1000. As such, program memory 1020 and data memory 1030 may comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 1010 may comprise multiple individual processors (not shown), each of which implements a portion of the functionality described above. In such case, multiple individual processors may be commonly connected to program memory 1020 and data memory 1030 or individually connected to multiple individual program memories and/or data memories. More generally, persons of ordinary skill in the art will recognize that various protocols and other functions of apparatus 1000 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1040 may comprise transmitters, receivers, signal processors, ASICs, antennas, beamforming units, and other circuitry that enables apparatus 1000 to communicate with other equipment such as, in some embodiments, a plurality of compatible user equipments (UEs). In some embodiments, radio network interface may comprise various protocols or protocol layers, such as the LTE PHY, MAC, RLC, PDCP, and RRC layer protocols standardized by 3GPP, improvements thereto such as described herein with reference to one of more FIGS. 5 through 8, or any other higher-layer protocols utilized in conjunction with radio network interface 1040. In some embodiments, the radio network interface 1040 may comprise a PHY layer based on orthogonal frequency division multiplexing (OFDM) or orthogonal frequency division multiple access (OFDMA) technologies. In some embodiments, radio network interface 1040 comprises circuitry that enables apparatus 1000 to communicate with eNBs in the E-UTRAN, including circuitry embodying the X2 interface protocols standardized by 3GPP, and improvements thereto such as described herein with reference to one of more FIGS. 5 through 8

Core network interface 1050 may comprise transmitters, receivers, and other circuitry that enables apparatus 1000 to communicate with other equipment in a core network such as, in some embodiments, circuit-switched (CS) and/or packet-switched Core (PS) networks. In some embodiments, core network interface 1050 may comprise the 51 interface standardized by 3GPP. In some embodiments, core network interface 1050 may comprise one or more interfaces to one or more SGWs, MMEs, SGSNs, GGSNs, and other physical devices that comprise functionality found in GERAN, UTRAN, E-UTRAN, and CDMA2000 core networks that are known to persons of ordinary skill in the art. In some embodiments, these one or more interfaces may be multiplexed together on a single physical interface. In some embodiments, lower layers of core network interface 1050 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

OA&M interface 1060 may comprise transmitters, receivers, and other circuitry that enables apparatus 1000 to communicate with external networks, computers, databases, and the like for purposes of operations, administration, and maintenance of apparatus 1000 or other network equipment operably connected thereto. Lower layers of OA&M interface 1060 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 1040, core network interface 1050, and OA&M interface 1060, or one or more portions of such interfaces, may be multiplexed together on a single physical interface, such as the exemplary physical interfaces listed above.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatuses, whether functionally in cooperation with or independently of each other. Moreover, devices and apparatuses may be implemented in a distributed fashion throughout a system, so long as the functionality of the device or apparatus is preserved. Such and similar principles are considered as known to a skilled person.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

1. A method for configuring a wireless network comprising a first cell and plurality of second cells utilizing a common frequency spectrum, wherein the coverage area for the first cell substantially comprises the coverage areas for the second cells, comprising:
receiving information related to first cell and the plurality of second cells;
determining, for each particular cell of the plurality of second cells, a level of interference from the first cell that is sustainable for operation of the particular cell based on the received information; and
configuring the first cell with the determined levels of interference corresponding to the plurality of second cells.

2. The method of claim 1, wherein the first cell is a macro cell and the plurality of second cells are pico cells.

3. The method of claim 1, wherein the information related to the first cell and plurality of second cells comprises the geographic location for each of the respective cells.

4. The method of claim 1, wherein the information related to the plurality of second cells comprises the cell range expansion (CRE) for each of the plurality of second cells.

5. The method of claim 1, wherein determining a level of interference for a particular cell comprises selecting one of a plurality of enumerated interference levels.

6. The method of claim 2, wherein:
the wireless network comprises an Evolved UMTS Terrestrial Radio Access Network (E-UTRAN); and
configuring the first cell comprises sending a message to the evolved Node B (eNB) serving the macro cell coverage area.

7. A method for configuring a wireless network comprising a first cell and plurality of second cells utilizing a common frequency spectrum, wherein the coverage area for the first cell substantially comprises the coverage areas for the second cells, comprising:
receiving a message comprising sustainable levels of interference for each of the plurality of second cells;
determining a transmission pattern for the first cell based at least in part on the sustainable levels of interference for each of the plurality of second cells, wherein the transmission pattern comprises the transmit power levels for a physical-layer (PHY) signal in a plurality of subframes;
for each interference level represented within the received message, determining one or more measurement parameters related to the transmission pattern for the first cell; and
configuring each of the plurality of second cells with the measurement parameters determined for the interference level corresponding to that particular cell.

8. The method of claim 7, wherein the first cell is a macro cell and the plurality of second cells are pico cells.

9. The method of claim 8, wherein:
the wireless network comprises an Evolved UMTS Terrestrial Radio Access Network (E-UTRAN);
the PHY signal comprises at least one of a Physical Downlink Shared Channel (PDSCH) and a Physical Downlink Control Channel (PDCCH); and
configuring a second cell comprises sending a message to the evolved Node B (eNB) serving the second cell's coverage area over the X2 interface.

10. The method of claim 7, wherein the transmission pattern comprises a plurality of different non-zero transmit power levels for the PHY signal in the plurality of subframes.

11-14. (canceled)

15. A method for determining whether to hand over a communication device from a first cell to a second cell in a wireless network, wherein the first and second cells utilize a common frequency spectrum and the coverage area for the first cell substantially comprises the coverage area for the second cell, comprising:
determining that the device is proximate to the coverage area for the second cell; determining a sustainable interference level for the second cell;
determining one or more measurement parameters for the second cell based on the transmission pattern for the first cell and the sustainable interference level for the second cell, wherein the transmission pattern comprises the transmit power levels for a physical-layer (PHY) signal in a plurality of subframes;
configuring the device with the measurement parameters; and
receiving, from the device, measurements made on a signal transmitted from the second cell according to the measurement parameters.

16. The method of claim 15, wherein the first cell is a macro cell and the second cell is a pico cell.

17. The method of claim 16, wherein:
the wireless network comprises an Evolved UMTS Terrestrial Radio Access Network (E-UTRAN);
the PHY signal comprises at least one of a Physical Downlink Shared Channel (PDSCH) and a Physical Downlink Control Channel (PDCCH); and
configuring the device comprises sending a Radio Resource Control (RRC) message comprising the measurement parameters.

18-19. (canceled)

20. The method of claim 15, wherein the one or more measurement parameters comprises a measurement subset of subframes and a parameter characterizing the transmit power level of the PHY signal during the subframes of the measurement subset.

21-44. (canceled)

45. An apparatus capable configuring a wireless network comprising a first cell and plurality of second cells utilizing a common frequency spectrum, wherein the coverage area for the first cell substantially comprises the coverage areas for the second cells, comprising, the apparatus comprising:
a transmitter;
a receiver;
a processor; and
at least one memory including program code that, when executed by the processor, causes the apparatus to:
receive information related to first cell and the plurality of second cells;
determine, for each particular cell of the plurality of second cells, a level of interference from the first cell that is sustainable for operation of the particular cell based on the received information; and
configure the first cell with the determined levels of interference corresponding to the plurality of second cells.

46. The apparatus of claim 45, wherein the first cell is a macro cell and the plurality of second cells are pico cells.

47. The apparatus of claim 45, wherein the information related to the first cell and plurality of second cells comprises the geographic location for each of the respective cells.

48. The apparatus of claim 45, wherein the information related to the plurality of second cells comprises the cell range expansion (CRE) for each of the plurality of second cells.

49. The apparatus of claim 45, wherein the program code that, when executed by the processor, causes the apparatus to determine a level of interference for a particular cell comprises program code that, when executed by the processor, causes the apparatus to select one of a plurality of enumerated interference levels.

50. The apparatus of claim 46, wherein:
the apparatus is an operations, administration, and maintenance (OA&M) server;
the wireless network comprises an Evolved UMTS Terrestrial Radio Access Network (E-UTRAN); and
the program code that, when executed by the processor, causes the apparatus to configure the first cell comprises program code that, when executed by the processor, causes the apparatus to send a message to the evolved Node B (eNB) serving the macro cell coverage area.

51-176. (canceled)
